(19) United States
(12) Patent Application Publication
(10) Pub. No.: US 2003/0237009 A1
(43) Pub. Date: Dec. 25, 2003

(54) Apparatus and method for protecting a movable storage medium

(75) Inventor: Jy-Youn Hwang, Daejeon Metropolitan-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/418,081

(22) Filed: Apr. 18, 2003

(30) Foreign Application Priority Data
Jun. 21, 2002 (KR) 2002-34877

(51) Int. Cl. G06F 1/26

(52) U.S. Cl. 713/300

(57) ABSTRACT

An apparatus and method minimizing power consumption and protecting a movable storage medium in the apparatus by supplying power to the movable storage medium only during downloading of data from the memory stick. A movable storage medium protector in the apparatus supplies power to operate the movable storage medium only during the downloading of the data from the movable storage medium.

### CROSS-REFERENCE TO RELATED APPLICATIONS

This application claims the priority of Korean Patent Application No. 2002-34877, filed Jun. 21, 2002 in the Korean Intellectual Property Office (KIPO), the disclosure of which is incorporated herein in its entirety by reference.

### BACKGROUND OF THE INVENTION

1. Field of the Invention

The present invention relates to an apparatus and method for protecting a movable storage medium, and more particularly, to an apparatus and method for protecting a movable storage medium supplying power to operate a memory stick included in a digital appliance only when the memory stick is downloading data, thereby minimizing data loss in the memory stick and power consumption by the digital appliance.

2. Description of the Related Art

A memory stick is a newly developed kind of movable (i.e., removable) flash storage medium (i.e., non-volatile memory), which is used as a movable recording medium. In general, the memory stick is a compact movable recording medium having the dimensions of 21.5×50×2.8 mm. The memory stick does not require a controller as in smart media and thus allows a higher degree of freedom in device design. Because use of digital appliances, such as digital cameras, MPEG-1 Audio Player 3 (MP3) players, and digital versatile disc (DVD) players, has become more widespread, memory sticks that are non-volatile memory, removable, small (compact) and high capacity and that can be used in digital appliances have been developed.

However, if a memory stick is separated from the digital appliance in which the memory stick is installed, while power to the digital appliance is on, data stored in the memory stick may be erased.

### SUMMARY OF THE INVENTION

Accordingly the present invention provides an apparatus, such as a digital appliance, protecting a movable storage medium, such as a memory stick, provided therein, by supplying power to operate the memory stick built in the digital appliance only when the memory stick is downloading data, thereby minimizing data loss in the memory stick and power consumption.

The present invention also provides a method of protecting a movable storage medium, such as a memory stick, by supplying power to operate the memory stick built in an apparatus, such as a digital appliance, only when the memory stick is downloading data, thereby minimizing data loss in the memory stick and power consumption.

Additional aspects and advantages of the invention will be set forth in part in the description which follows and, in part, will be obvious from the description, or may be learned by practice of the invention.

The present invention may be achieved by an apparatus protecting a movable storage medium, the apparatus comprising a movable storage medium storing data; and a movable storage medium protector supplying power to operate the storage medium only during downloading of (i.e., to download) the data from the storage medium.

According to an aspect of the invention, the storage medium protector comprises a switching unit switching on or off the power supply to the movable storage medium; and a controller checking input to or output from the storage medium and controlling the switching unit to supply the power to the storage medium only during the downloading of the data from the storage medium.

According to an aspect of the invention, the controller comprises a buffer storing at once the data downloaded from the storage medium.

The present invention may be also achieved by a method of protecting a movable storage medium, comprising checking if data is to be downloaded from the movable storage medium; and determining whether power is to be supplied to the storage medium according to the checking.

According to an aspect of the invention, the power is supplied to the storage medium to operate the storage medium when the data in the movable storage medium is being downloaded, the power is cut off to the storage medium when the data in the storage medium is not being downloaded.

### BRIEF DESCRIPTION OF THE DRAWINGS

The above and/or other aspects and advantages of the present invention will become more apparent and more readily appreciated from the following description of the embodiments, taken in conjunction with the accompanying drawings of which:

FIG. 1 is a functional block diagram of an apparatus protecting a movable storage medium provided therein, according to an embodiment of the present invention;

FIG. 2 is a structure diagram of a memory stick protector shown in FIG. 1, according to an embodiment of the present invention; and

FIG. 3 is a flowchart of protecting the movable storage medium in the apparatus shown in FIG. 1, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

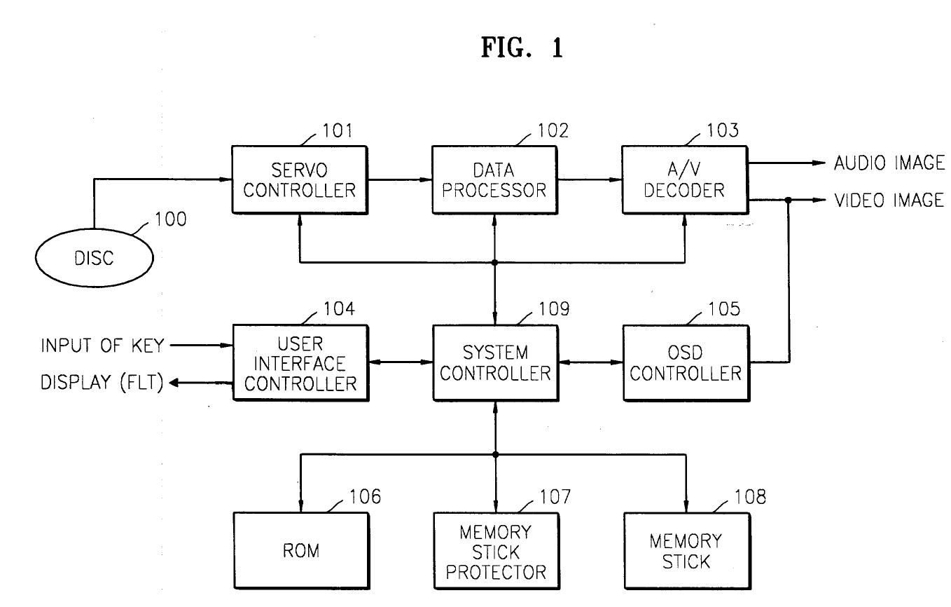

FIG. 1 is a functional block diagram of an apparatus, such as a digital appliance, protecting a movable storage medium provided therein, according to an embodiment of the present invention. In particular, in FIG. 1, as an example, the apparatus is an optical disc reproducer, such as a DVD player, etc., having a memory stick as the movable storage medium. Referring to FIG. 1, the apparatus comprises a disc 100, a servo controller 101, a data processor 102, an audio and/or video (A/D) decoder 103, a user interface controller 104, an on-screen-display (OSD) controller 105, a read-only memory (ROM) 106, a memory stick protector 107, a memory stick 108 (i.e., the movable storage medium), and a system controller 109. Typically, a central computer processor (CPU), such as the system controller 109, is in communication with various components of the apparatus to control overall operations of the apparatus, such as the DVD player.

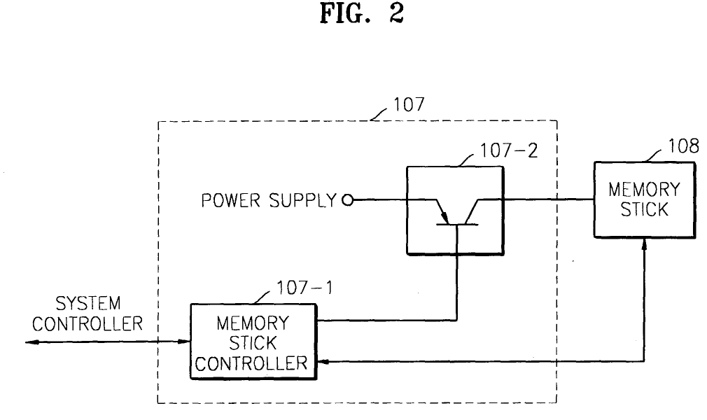

FIG. 2 is a structure diagram of the memory stick protector 107 of FIG. 1, according to an embodiment of the present invention. Referring to FIG. 2, typically, the memory stick protector 107 comprises a memory stick controller 107-1 and a protection switching unit 107-2.

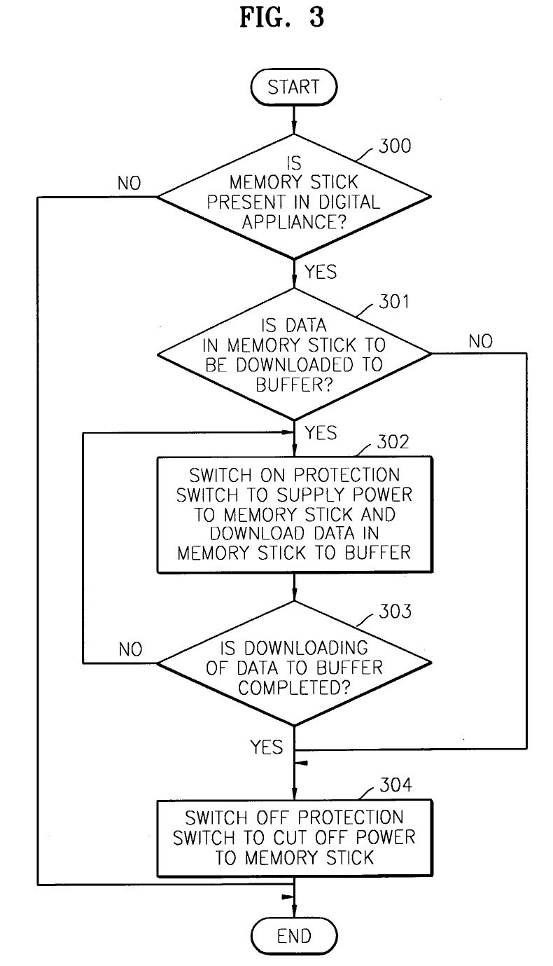

FIG. 3 is a flowchart of protecting the movable storage medium in the apparatus shown in FIG. 1, according to an embodiment of the present invention. Referring to FIG. 3, at operation 300, it is determined whether a memory stick is in a digital appliance. If, at operation 300, a memory stick is not installed in the digital appliance, the digital appliance performs typical operations when the memory stick is not installed. If, at operation 300, a memory stick is installed in the digital appliance, at operation 301, it is determined whether data stored in the memory stick is to be downloaded to a buffer. If, at operation 301, it is determined that the data is to be downloaded to the buffer, at operation 302, a protection switch is turned on to supply power to the memory stick and the data in the memory stick is downloaded to the buffer. At operation 303, it is checked whether the downloading of the data from the memory stick to the buffer is complete. If, at operation 303, the downloading is complete, at operation 304, the protection switch is turned off to cut off the power to the memory stick. If, at operation 303, the downloading is not complete, at operation 302, the protection switch is retained on to continue supplying the power to the memory stick. Further, if at operation 301, it is determined that there is no data to be downloaded from the memory stick, at operation 304, the protection switch is turned off/retained off to cut off the power to the memory stick. Accordingly, the memory stick is only powered to download data therefrom, so that if the memory stick is removed from the apparatus while the apparatus is powered, data loss on the memory stick is minimized because the memory stick is likely not powered during the removal. Further, supplying power to the memory stick only during data downloading decreases power consumption by the apparatus, thereby preserving battery life.

Hereinafter, as an example, a DVD player (an apparatus) protecting a movable storage medium provided in the DVD player, according to an embodiment of the present invention will be explained in detail with reference to FIGS. 1 through 3. In FIG. 1, the system controller 109 is in communication with the various components of the DVD player to control the overall operations of the DVD player. The servo controller 101 rotates the disc 100 to control servos for reading data from the disc 100. The data processor 102 divides a signal, which is read by an optical pickup (not shown) in the servo controller 101, into audio and video signals, processes the divided audio and video signals, and outputs the processed signals to the A/V decoder 103. The A/V decoder 103 decodes the audio and/or video signals output (received) from the data processor 102 and outputs the decoded signals as audio and/or video images to be further processed by another device (not shown), and/or to be heard and/or viewed by a user via an output unit (not shown), such as speakers, a display screen, etc.

The user interface controller 104 displays playback information, such as front keys, a received remotely-controlled key, and playback time, on a fluorescent light tube (FLT) (not shown) for an interface between a user and the digital appliance, e.g., the DVD player. Typically, the OSD controller 105 combines the decoded video signal with an OSD signal, and controls output of the OSD signal to display this signal on a screen. The ROM 106 stores various types of programs and data for running the DVD player (not shown).

The memory stick 108 is a storage medium storing user data and can be separated from the DVD player, thereby providing a movable storage medium 108. The memory stick protector 107 is in communication with the memory stick 108 to prevent data loss in the memory stick 108 and unnecessary power consumption by the DVD player. Referring to FIG. 2, typically, the memory stick controller 107-1 also comprises a buffer (not shown) storing data downloaded from the memory stick 108 in response to (as controlled by) system controller 109 signals. In the memory stick protector 107, the memory stick controller 107-1 protects the memory stick 108, and the protection switching unit 107-2 supplies power to the memory stick 108 under the control of the memory stick controller 107-1. The memory stick controller 107-1 operates (controls) the protection switching unit 107-2 to supply power to the memory stick 108, only when the memory stick 108 downloads data to the buffer in the memory stick controller 107-1. Otherwise, the memory stick controller 107-1 does not allow operation of the protection switching unit 107-2 to cut off power to the memory stick 108.

Accordingly, for example, during a play operation of the DVD player, a video image is reproduced with data downloaded to the buffer in the memory stick controller 107-1, thereby the reproduction of the video image is not affected by the power cut off to the memory stick 108. That is, according to the present invention, power is provided to the memory stick 108 only when data in the memory stick 108 is downloaded to the buffer in the memory stick controller 107-1. Accordingly, an apparatus and method protecting a movable storage medium according to the present invention can minimize data loss in the memory stick 108 and decrease power consumption of the apparatus which is advantageous in a battery-operated mobile digital appliance.

Hereinafter, a method of protecting a movable storage medium provided in an apparatus, using a DVD player as an example, will be described in detail with reference to FIG. 3. At operation 300, it is determined whether the memory stick 108 is in the digital appliance (i.e., the DVD player). Typically, the presence of the memory stick 108 in the digital appliance is sensed by the system controller 109 that controls the overall operations of the digital appliance.

If determined at operation 300 that the memory stick 108 is present in the digital appliance, at operation 301, it is determined whether data in the memory stick 108 is to be downloaded to the buffer of the memory stick controller 107-1. In particular, when the user interface controller 104 receives an input download key by a user (for example, an input play command), the user interface controller 104 transmits the input download key to the system controller 109. Next, the system controller 109 operates (controls) the memory stick protector 107 by signaling to the memory stick protector 107 that data is to be downloaded from the memory stick so that the downloaded data can be played (reproduced) under the control of the system controller 109.

If, at operation 301, the downloading of the data stored in the memory stick 108 to the buffer of the memory stick controller 107-1 is determined, at operation 302, the protection switching unit 107-2 is switched on to supply power to the memory stick 108 and the data stored in the memory stick 108 is downloaded to the buffer of the memory stick controller 107-1. In particular, at operation 302, typically all of the stored data is downloaded at once to the buffer, thereby allowing efficient data reproduction from the buffer without continuing power supply power to the memory stick 108.

After operation 302, the system at operation 303 checks whether the downloading of the data from the memory stick 108 to the buffer of the memory stick controller 107-1 has been completed, and if, at operation 303, the downloading is complete, at operation 304, the protection switching unit 107-1 is switched off to cut off power to the memory stick 108.

According to the FIG. 3 operation logic, the memory stick controller 107-1 turns on the protection switching unit 107-2 to supply power to the memory stick 108 only during the downloading of the data stored in the memory stick 108 to the buffer of the memory stick controller 107-1, in response to a download signal (e.g., a user input play command, etc.) through the system controller 109. Otherwise, the memory stick controller 107-1 turns off the protection switching unit 107-2 to cut off power to the memory stick 108. More particularly, during the operation of a DVD player, typically a video image is reproduced with all data downloaded at once to the buffer in the memory stick controller 107-1, and therefore, reproduction of the video image is not affected by the power cut off to the memory stick 108. Accordingly, because power is provided to the memory stick 108 only when data in the memory stick 108 is downloaded to the buffer in the memory stick controller 107-1, data loss in the memory stick 108 and power consumption of the DVD player can be minimized. Minimizing power consumption can be advantageous to a battery-operated mobile appliance. The present invention provides a memory stick protector controlling power supply to the memory stick according to data access requests (i.e., read or write requests) to the memory stick. Therefore, although in the above-described embodiment the memory stick protector controls power supply to the memory stick according to memory-stick data download requests, the present invention is not limited to such configuration, and the memory stick protector can control the power supply to the memory stick according to memory-stick data record (upload) requests to record (write) data via the buffer of the memory stick protector to the memory stick. The processes of the present invention as embodied in the memory stick protector 107 can be implemented in computing hardware and/or software.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An apparatus protecting a movable storage medium, comprising:
a movable storage medium storing data; and
a movable storage medium protector supplying power to operate the storage medium only to download the data from the storage medium.

2. The apparatus of claim 1, wherein the storage medium protector comprises:
a switch switching on or off the power to the movable storage medium; and
a controller checking input to or output from the storage medium and controlling the switch to supply the power to the storage medium only during the downloading of the data from the storage medium.

3. The apparatus of claim 2, wherein the controller comprises a buffer storing at once the data downloaded from the storage medium.

4. A method of protecting a movable storage medium, comprising:
checking if data is to be downloaded from the movable storage medium; and
determining whether to supply power to the storage medium according to the checking.

5. The method of claim 4, wherein the power is supplied to the storage medium to operate the storage medium when the data in the storage medium is being downloaded, and the power is cut off to the storage medium when the data in the storage medium is not being downloaded.

6. A memory stick protector in a digital device, comprising:
a controller in communication with a memory stick and controlling power supply to the memory stick according to a processor data access request to the memory stick.

7. The memory stick protector of claim 6, wherein the controller comprises:
a buffer storing data downloaded from the memory stick or storing data to be recorded in the memory stick; and
a switch switching on or off the power supply to the memory stick during the processor data access request to download the data from the memory stick into the buffer or to record the data from the buffer into the memory stick.
